(19) United States
(12) Patent Application Publication
(10) Pub. No.: US 2010/0297378 A1
(43) Pub. Date: Nov. 25, 2010

(54) PATTERNED FIBROUS STRUCTURES AND METHODS FOR MAKING SAME

(76) Inventors: Andre Mellin, Amberley Village, OH (US); Jason Merrill Jones, Lebanon, OH (US); Thomas Timothy Byrne, West Chester, OH (US); Kevin Benson McNeil, Loveland, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/468,557

(22) Filed: May 19, 2009

(51) Int. Cl. B32B 3/10; B32B 5/14; B29C 59/04

(52) U.S. Cl. 428/43; 428/156; 264/293

(57) ABSTRACT

Patterned fibrous structures having a pattern with a repeat unit length of greater than 28 cm and methods for making such fibrous structures are provided.

### FIELD OF THE INVENTION

The present invention relates to patterned fibrous structures and more particularly to patterned fibrous structures having a pattern with a repeat unit length of greater than 28 cm and methods for making such fibrous structures.

### BACKGROUND OF THE INVENTION

Fibrous structures with patterns, embossed or otherwise, are known in the art. For example, fibrous structures, such as toilet paper and/or paper towels, comprising individual sheets separably connected to one another having a pattern that exhibits a repeat unit length along the individual sheets of less than 26 cm are known. However, such known patterned fibrous structures exhibit consumer negatives with respect to their aesthetics. Apparently, the consumers do not prefer to see the same design over and over again on each sheet or every two sheets. It has been found that at least some consumers desire to see a variety of designs over three, four or even more sheets.

Accordingly, there is a need for a fibrous structure comprising a pattern that exhibits a repeat unit length of greater than 28 cm and methods for making such a fibrous structure.

### SUMMARY OF THE INVENTION

The present invention fulfills the needs described above by providing a fibrous structure comprising a pattern that exhibits a repeat unit length of greater than 28 cm and methods for making such a fibrous structure.

In one example of the present invention, a fibrous structure comprising individual sheets separably connected to one another wherein the fibrous structure comprises a pattern having a repeat unit length along two or more of the individual sheets of greater than 28 cm (about 11 inches) and/or greater than 30 cm (about 12 inches) is provided.

In another example of the present invention, a fibrous structure comprises a first pattern having a repeat unit length of greater than 28 cm and/or greater than 30 cm and a second pattern, different from the first pattern, having a repeat unit length of greater than 28 cm and/or greater than 30 cm, wherein the first pattern has a pattern depth of at least 50 μm greater than the pattern depth of the second pattern, is provided. The first and second patterns may be registered to one another.

In still another example of the present invention, a single- or multi-ply sanitary tissue product comprising a fibrous structure according to the present invention is provided.

In even still another example of the present invention, a method for making a fibrous structure, the method comprising the step of imparting a pattern to a fibrous structure comprising individual sheets separably connected to one another wherein the pattern exhibits a repeat unit length along two or more of the individual sheets of greater than 28 cm, is provided.

Accordingly, the present invention provides a fibrous structure comprising a pattern that exhibits a repeat unit length of greater than 28 cm and methods for making such a fibrous structure.

### BRIEF DESCRIPTION OF THE DRAWINGS

FIG. 1 is a top plan view of an example of a fibrous structure according to the present invention;

FIG. 2 is a schematic representation of another example of a design element according to the present invention;

FIG. 3 is a schematic representation of the primary design element of the design element of FIG. 2;

FIG. 4A is a schematic representation of a secondary design element of the design element of FIG. 2;

FIG. 4B is a schematic representation of the secondary design element of FIG. 4A with centroids identified;

FIG. 5A is a schematic representation of a secondary design element of the design element of FIG. 2;

FIG. 5B is a schematic representation of the secondary design element of FIG. 5A with centroids identified;

FIG. 6 is a schematic representation of the secondary design element of FIG. 4A with its centroid identified;

FIG. 7 is a schematic representation of the secondary design element of FIG. 5A with its centroid identified; and

FIG. 8 is a schematic representation of the design element of FIG. 2 with the centroids of its primary design element and secondary design elements identified.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm3) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises a fibrous structure according to the present invention.

The sanitary tissue products and/or fibrous structures of the present invention may exhibit a basis weight of greater than 15 g/m2 (9.2 lbs/3000 ft²) to about 120 g/m² (73.8 lbs/3000 ft²) and/or from about 15 g/m² (9.2 lbs/3000 ft²) to about 10 g/m² (67.7 lbs/3000 ft²) and/or from about 20 g/m² (12.3 lbs/3000 ft²) to about 100 g/m² (61.5 lbs/3000 ft²) and/or from about 30 (18.5 lbs/3000 ft²) to 90 g/m² (55.4 lbs/3000 ft²). In addition, the sanitary tissue products and/or fibrous structures of the present invention may exhibit a basis weight between about 40 g/m² (24.6 lbs/3000 ft²) to about 120 g/m² (73.8 lbs/3000 ft²) and/or from about 50 g/m² (30.8 lbs/3000 ft²) to about 10 g/m² (67.7 lbs/3000 ft²) and/or from about 55 g/m² (33.8 lbs/3000 ft²) to about 105 g/m² (64.6 lbs/3000 ft²) and/or from about 60 (36.9 lbs/3000 ft²) to 100 g/m² (61.5 lbs/3000 ft²).

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density (measured at 95 g/in²) of less than about 0.60 g/cm³ and/or less than about 0.30 g/cm³ and/or less than about 0.20 g/Cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprises additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

“Line element embossment” as used herein means an embossment that comprises a continuous line that has an aspect ratio of greater than 1.5:1 and/or greater than 1.75:1 and/or greater than 2:1 and/or greater than 5:1. In one example, the line element embossment exhibits a length of at least 2 mm and/or at least 4 mm and/or at least 6 mm and/or at least I cm to about 10.16 cm and/or to about 8 cm and/or to about 6 cm and/or to about 4 cm.

“Dot embossment” as used herein means an embossment that exhibits an aspect ratio of about 1:1. Non-limiting examples of dot embossments are embossments that are shaped like circles, squares and triangles.

“Design Element” as used herein means a discrete object present on a surface of a fibrous structure. Non-limiting examples of design elements include flowers, butterflies, animals, and geometric shapes. The discrete object may comprise a primary design element and one or more secondary design elements. The primary and secondary design elements associate with each other to form the design element.

“Primary Design Element” as used herein means that portion of the design element that identifies what the design element is. It is an essential part of the design element. For example, the primary design element of a flower design element is the group of petals that form the essential part of the flower.

“Secondary Design Element” as used herein means that portion of the design element that is not essential to the design element. For example, the secondary design element may be a stem or branch off of a primary design element of a flower design element.

“Water-resistant” as it refers to a pattern means that a pattern retains its structure and/or integrity after being saturated by water and the pattern can still be seen by consumer.

### Fibrous Structure

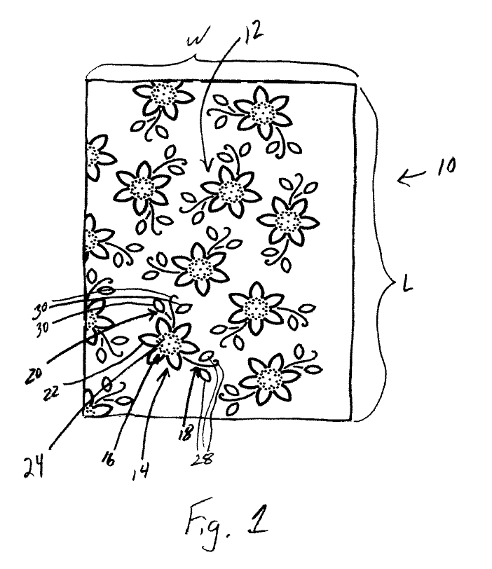

As shown in FIG. 1, the fibrous structure 10 of the present invention comprises a pattern 12. The pattern 12 may be an emboss pattern, imparted by passing a fibrous structure through an embossing nip comprising at least one patterned embossing roll, and/or a water-resistant pattern, typically imparted during the fibrous structure-making process.

The pattern 12 may comprise one or more design elements 14. The design elements may comprise a primary design element 16 and at least two, different secondary design elements 18, 20. The primary design element 16 is an essential part of a flower. The primary design element 16 may comprise one or more line element embossments 22. As is shown in FIG. 1, the primary design element 16 may comprise one or more dot embossments 24. The dot embossments 24 may be substantially located within the center of the primary design element 16.

The ratio of patterned area of a primary design element to patterned area of an associated secondary design element is greater than 1.2:1 and/or greater than 1.4:1 and/or greater than 1.5:1 and/or greater than 1.75:1. The patterned area of a primary design element and/or secondary design element is determined by the Patterned Area Test Method described herein.

The design element may comprise two or more and/or three or more secondary design elements.

The secondary design elements may comprise the same shapes and/or different shapes of embossments, especially line element embossments.

In one example, the primary design element 16 may exhibit reflection symmetry. In another example, the primary design element 16 may exhibit rotational symmetry. In yet another example, the primary design element 16 may exhibit both reflection and rotational symmetry.

One of the two, different secondary design elements 18 comprises one or more line element embossments 28. The line element embossments 28 may combine to form a stem with leaves. In addition to line element embossments 28, the secondary design element 18 may comprise one or more dot embossments (not shown).

The other of the two, different secondary design elements 20 comprises one or more line element embossments 30. The line element embossments 30 may combine to form a stem with leaves. In addition to line element embossments 30, the secondary design element 20 may comprise one or more dot embossments (not shown).

The line element embossments may be enclosed line element embossments 28, 30 and/or may be partially enclosed line element embossments 24.

The two, different secondary design elements 18, 20, are associated with each other via the primary design element 14 at an angle α of greater than 120° to less than 175° and/or from greater than 120° to about 150° as measured by the Secondary Design Element Angle Test Method.

The pattern 12 may exhibit a repeat unit length L of greater than 30 cm (about 12 inches) and/or greater than 32 cm and/or greater than 34 cm. In one example, the pattern 12 exhibits a repeat unit width W greater than 10 cm and/or 12.7 cm or greater and/or 14 cm or greater and/or 16 cm or greater.

The fibrous structure 10 may comprise individual sheets that are separably connected to each other, in sequence, over which the repeat unit length L extends. The individual sheets may be connected by lines of weakness, such as lines of perforations. The pattern may be registered to every third or greater line of weakness.

The fibrous structure 10 may be in roll form. For example, the fibrous structure 10 may be convolutely wound upon itself to form a roll or about a core to form a roll.

The pattern 12 may comprise one or more design elements as shown in FIG. 1. In one example, every second sheet of the fibrous structure comprises a complete design element rather than a partial design element, such as a design element that is truncated by an edge of the fibrous structure and/or by a line of perforation.

Even though emboss patterns are exemplified above, the design elements of the present invention may be created by contacting a patterned belt comprising a design element forming element with a fibrous slurry and/or a fibrous structure in need of a design element.

In one example, a fibrous structure according to the present invention comprises an emboss pattern (first pattern) and a pattern formed by a patterned belt (second pattern). In yet another example, a fibrous structure according to the present invention comprises an emboss pattern (first pattern) and a pattern formed by a patterned belt (second pattern) wherein the emboss pattern is registered to the pattern formed by the patterned belt.

In one example, when the fibrous structure comprises two patterns, one of the patterns may exhibit a minimum pattern depth of at least 50 μm greater than the pattern depth of the other pattern. The pattern depth is measured using the Pattern Depth Test Method described herein.

### Method for Making a Fibrous Structure

The fibrous structures of the present invention may be made by any suitable process.

In one example, a fibrous structure according to the present invention is made by a method comprising the step of imparting a pattern comprising one or more design elements comprising a primary design element and two, different secondary design elements that are associated with each other via the primary design element at an angle of greater than 120° but less than 175° to a fibrous structure.

In one example, the step of imparting a pattern to a fibrous structure comprises contacting a molding member comprising a pattern with a fibrous structure such that the pattern is imparted to the fibrous structure. The molding member may be a patterned belt that comprises a pattern.

In another example, the step of imparting a pattern to a fibrous structure comprises passing a fibrous structure through an embossing nip formed by at least one embossing roll comprising a pattern such that the pattern is imparted to the fibrous structure.

### Non-limiting Example

A fibrous structure in accordance with the present invention is prepared using a fibrous structure making machine having a layered headbox having a top chamber, a center chamber, and a bottom chamber. A eucalyptus fiber slurry is pumped through the top headbox chamber, a eucalyptus fiber slurry is pumped through the bottom headbox chamber (i.e. the chamber feeding directly onto the forming wire) and, finally, an NSK fiber slurry is pumped through the center headbox chamber and delivered in superposed relation onto the Fourdrinier wire to form thereon a three-layer embryonic web, of which about 33% of the top side is made up of the eucalyptus blended fibers, 33% is made of the eucalyptus fibers on the bottom side and 33% is made up of the NSK fibers in the center. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of substantially machine direction oriented linear channels having a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 11 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The fibrous structure is wound in a roll using a surface driven reel drum having a surface speed of about 656 feet per minute. The fibrous structure is subjected to an embossing operation that imparts one or more line element embossments to a surface of the fibrous structure. The fibrous structure may be subsequently converted into a two-ply sanitary tissue product having a basis weight of about 39 g/m². For each ply, the outer layer having the eucalyptus fiber furnish is oriented toward the outside in order to form the consumer facing surfaces of the two-ply sanitary tissue product.

The sanitary tissue product is soft, flexible and absorbent.

### Test Methods

Unless otherwise specified, all tests described herein including those described under the Definitions section and the following test methods are conducted on samples that have been conditioned in a conditioned room at a temperature of 73° F.±4° F. (about 23° C.±2.2° C.) and a relative humidity of 50%±10% for 2 hours prior to the test. All plastic and paper board packaging materials must be carefully removed from the paper samples prior to testing. Discard any damaged product. All tests are conducted in such conditioned room.

### Basis Weight Test Method

Basis weight of a fibrous structure sample is measured by selecting twelve (12) usable units (also referred to as sheets) of the fibrous structure and making two stacks of six (6) usable units each. Perforation must be aligned on the same side when stacking the usable units. A precision cutter is used to cut each stack into exactly 8.89 cm×8.89 cm (3.5 in.×3.5 in.) squares. The two stacks of cut squares are combined to make a basis weight pad of twelve (12) squares thick. The basis weight pad is then weighed on a top loading balance with a minimum resolution of 0.01 g. The top loading balance must be protected from air drafts and other disturbances using a draft shield. Weights are recorded when the readings on the top loading balance become constant. The Basis Weight is calculated as follows:

$$Basis Weight ( lbs \text{/} 3000 {ft}^{2} ) = \frac{Weight of basis weight pad ( g ) \times 3000 {ft}^{2}}{\begin{matrix}453.6 g \text{/} lbs \times 12 ( usable units ) \times \\ [ \frac{12.25 {in}^{2} ( Area of basis weight pad )}{144 {in}^{2}} ]\end{matrix}}$$

$$Basis Weight ( g \text{/} {m}^{2} ) = \frac{Weight of basis weight pad ( g ) \times 10 , 000 {cm}^{2} \text{/} {m}^{2}}{\begin{matrix}79.0321 {cm}^{2} ( Area of basis weight pad ) \times \\ 12 ( usable units )\end{matrix}}$$

### Secondary Design Element Angle Test Method

The secondary design element angle between a primary design element and the secondary design elements of a design element is determined by the angle of the connections of the centroids of the second design elements with the centroid of the primary design element.

Each shape has a centroid in the x and y directions. The centroid of an area for a symmetrical object such as a square is located at the center of the object. For a complex object, the overall centroid is calculated by breaking the complex object into small less complex objects using a weighted average. The calculation of centroid uses the following equation:

$$\begin{matrix}{A}_{T} \overline{x} = {\int }_{Area} x d A & ⇒ \overline{x} = \frac{1}{{A}_{T}} {\int }_{Area} x d A \\ {A}_{T} \overline{y} = {\int }_{Area} y d A & ⇒ \overline{y} = \frac{1}{{A}_{T}} {\int }_{Area} y d A\end{matrix}$$

where A_{T} is the total area and x̅ and y̅ are the centroid of the body. The equation can be broken into integrals of smaller areas:

$$\begin{matrix}{A}_{T} \overline{x} = \sum {\int }_{{A}_{i}} {x}_{i} d {A}_{i} & ⇒ \overline{x} = \frac{1}{{A}_{T}} \sum {\int }_{{A}_{i}} {x}_{i} d {A}_{i} \\ {A}_{T} \overline{y} = \sum {\int }_{{A}_{i}} {y}_{i} d {A}_{i} & ⇒ \overline{y} = \frac{1}{{A}_{T}} \sum {\int }_{{A}_{i}} {y}_{i} d {A}_{i}\end{matrix}$$

If each integral is replaced with its centroid and area, the centroid of the entire body can be computed using:

$$\begin{matrix}{\int }_{{A}_{i}} {x}_{i} d {A}_{i} = {\overline{x}}_{i} {A}_{i} & {\int }_{{A}_{i}} {y}_{i} d {A}_{i} = {\overline{y}}_{i} {A}_{i} \\ {A}_{T} \overline{x} = \sum {\overline{x}}_{i} {A}_{i} & ⇒ \overline{x} = \frac{1}{{A}_{T}} \sum {\overline{x}}_{i} {A}_{i} \\ {A}_{T} \overline{y} = \sum {\overline{y}}_{i} {A}_{i} & ⇒ \overline{y} = \frac{1}{{A}_{T}} \sum {\overline{y}}_{i} {A}_{i}\end{matrix}$$

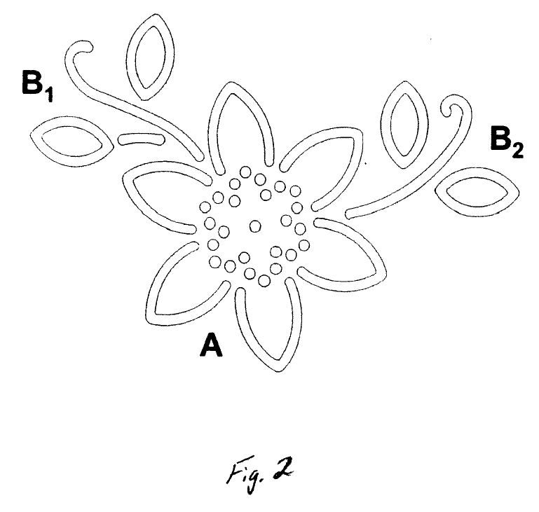

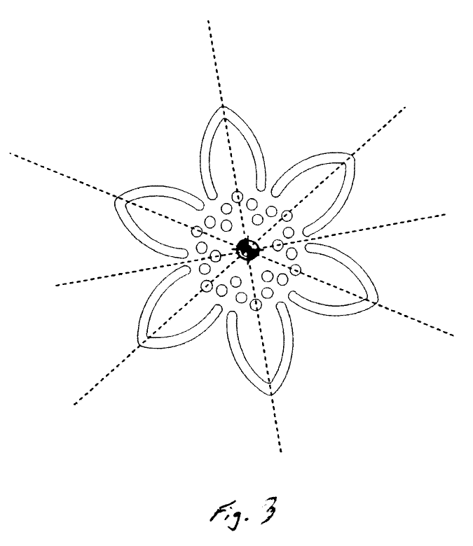

By way of example, the secondary design element angle of an example of a design element comprising a primary design element A, a secondary design element B₁ and another secondary design element B₂, shown in FIG. 2, of the present invention is measured as follows. As the primary design element A is 6-fold symmetrical, the centroid is the intersecting point of all the symmetry axes, as shown in FIG. 3.

The centroids of the secondary design elements B₁ and B₂ are calculated by breaking each secondary design element into shapes with individual centroids and applying the following:

$$\begin{matrix}{A}_{T} \overline{x} = \sum {\overline{x}}_{i} {A}_{i} & ⇒ \overline{x} = \frac{1}{{A}_{T}} \sum {\overline{x}}_{i} {A}_{i} \\ {A}_{T} \overline{y} = \sum {\overline{y}}_{i} {A}_{i} & ⇒ \overline{y} = \frac{1}{{A}_{T}} \sum {\overline{y}}_{i} {A}_{i}\end{matrix}$$

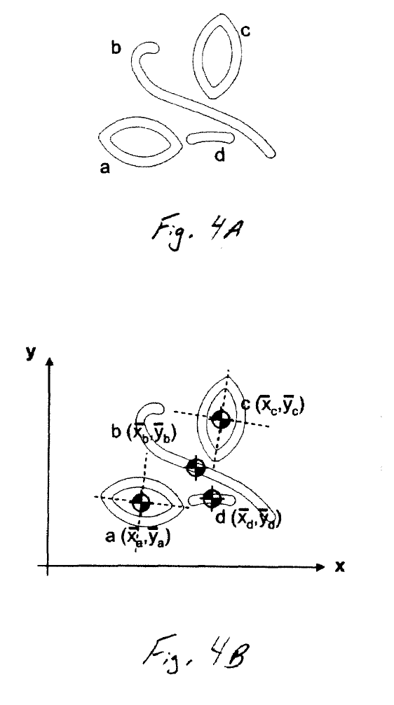

For secondary design element B₁, break it up into sub-secondary design elements a, b, c, d, as shown in FIGS. 4A and 4B. Determine the area of each sub-secondary design element a, b, c, d and sum the areas for the sub-secondary design elements to arrive at the total area of the secondary design element B₁.

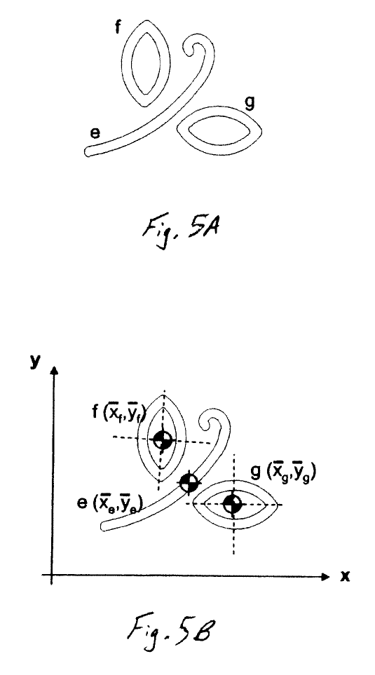

For secondary design element B₂, break it up into sub-secondary design elements e, f, g, as shown in FIGS. 5A and 5B. Determine the area of each sub-secondary design element e, f, g, and sum the areas for the sub-secondary design elements to arrive at the total area of the secondary design element B₂.

The centroids for the sub-secondary design elements a, c, f and g, which are shapes that have individual centroids are determined as shown in FIGS. 4B and 4B.

The centroids for the sub-secondary design elements b, d and e, which are shapes that do not have individual centroids, can be determined by calculating the centroid of a composed body as shown in FIGS. 4B and 5B.

The x and y centroid of each of the secondary design elements B₁ and B₂ are computed with the following equations.

$$\overline{x} = \frac{1}{{A}_{T}} \sum {\overline{x}}_{i} {A}_{i}$$

$$\overline{y} = \frac{1}{{A}_{T}} \sum {\overline{y}}_{i} {A}_{i}$$

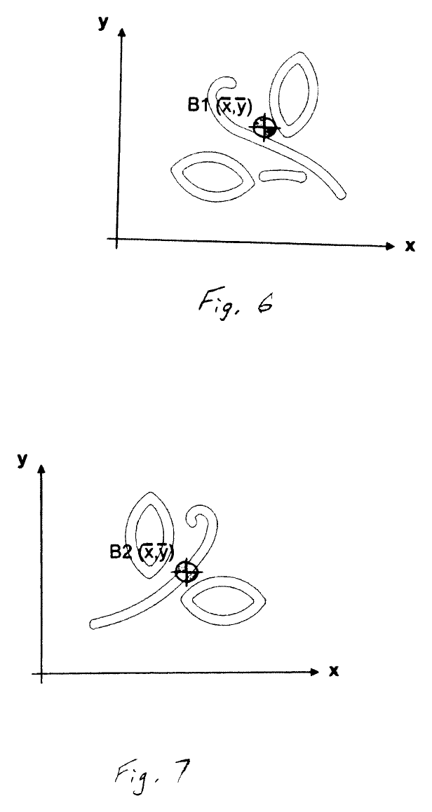

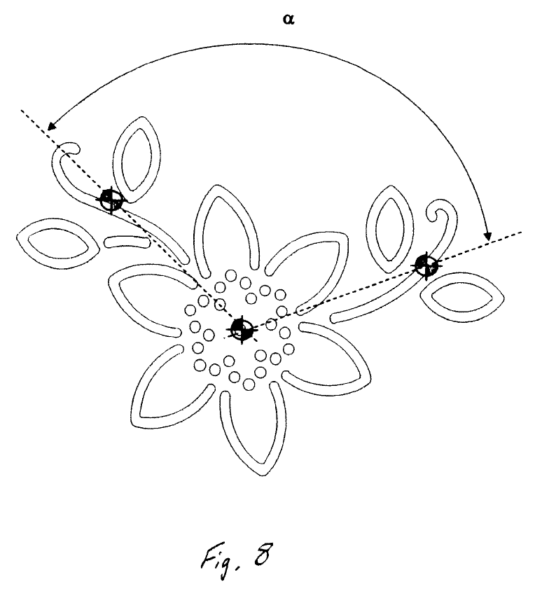

FIG. 6 shows the x̅ and y̅ centroid of secondary design element B₁. FIG. 7 shows the x̅ and y̅ centroid of secondary design element B₂.

FIG. 8 shows the design element with the centroids for the primary and secondary design elements identified and the secondary design element angle of the design element.

### Pattern Depth Test Method

The GFM Primos Optical Profiler system measures the surface height of a sample using the digital micro-mirror pattern projection technique. The result of the analysis is a map of surface height (z) vs. xy displacement. The system has a field of view of 27×22 mm with a resolution of 21 microns. The height resolution should be set to between 0.10 and 1.00 micron. The height range is 64,000 times the resolution.

To measure a fibrous structure sample do the following:
1. Turn on the cold light source. The settings on the cold light source should be 4 and C, which should give a reading of 3000K on the display;
2. Turn on the computer, monitor and printer and open the ODSCAD 4.0 Primos Software.
3. Select “Start Measurement” icon from the Primos taskbar and then click the “Live Pic” button.
4. Place a 30 mm by 30 mm sample of fibrous structure product conditioned at a temperature of 73° F.±2° F. (about 23° C.±1° C.) and a relative humidity of 50%±2% under the projection head and adjust the distance for best focus.
5. Click the “Pattern” button repeatedly to project one of several focusing patterns to aid in achieving the best focus (the software cross hair should align with the projected cross hair when optimal focus is achieved). Position the projection head to be normal to the sample surface.
6. Adjust image brightness by changing the aperture on the lens through the hole in the side of the projector head and/or altering the camera “gain” setting on the screen. Do not set the gain higher than 7 to control the amount of electronic noise. When the illumination is optimum, the red circle at bottom of the screen labeled “I.O.” will turn green.
7. Select Technical Surface/Rough measurement type.
8. Click on the “Measure” button. This will freeze on the live image on the screen and, simultaneously, the image will be captured and digitized. It is important to keep the sample still during this time to avoid blurring of the captured image. The image will be captured in approximately 20 seconds.
9. If the image is satisfactory, save the image to a computer file with “.omc” extension. This will also save the camera image file “.kam”.
10. To move the data into the analysis portion of the software, click on the clipboard/man icon.
11. Now, click on the icon “Draw Cutting Lines”. Make sure active line is set to line 1. Move the cross hairs to the lowest point on the left side of the computer screen image and click the mouse. Then move the cross hairs to the lowest point on the right side of the computer screen image on the current line and click the mouse. Now click on “Align” by marked points icon. Now click the mouse on the lowest point on this line, and then click the mouse on the highest point on this line. Click the “Vertical” distance icon. Record the distance measurement. Now increase the active line to the next line, and repeat the previous steps, do this until all lines have been measured (six (6) lines in total. Take the average of all recorded numbers, and if the units is not micrometers, convert it to micrometers (μm). This number is the pattern depth. Repeat this procedure for another image in the fibrous structure product sample and take the average of the pattern depths.

### Patterned Area Test Method

In order to determine the amount of patterned area occupied by a primary design element and/or a secondary design element, the areas of each sub-part making up the primary design element is calculated. The perimeter of each sub-part is measured along the outermost deflection of each sub-part out of the plane formed by the un-embossed portion. In other words the perimeter of each sub-part is defined by the start of any z-direction displacement in the sub-part.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fibrous structure comprising individual sheets separably connected to one another wherein the fibrous structure comprises a pattern having a repeat unit length along two or more of the individual sheets of greater than 28 cm.

2. The fibrous structure according to claim 1 wherein the individual sheets are separably connected to one another by lines of weakness.

3. The fibrous structure according to claim 2 wherein the lines of weakness are perforation lines.

4. The fibrous structure according to claim 2 wherein the pattern is registered with every third or greater line of weakness.

5. The fibrous structure according to claim 1 wherein the pattern comprises one or more design elements.

6. The fibrous structure according to claim 1 wherein the pattern exhibits a repeat unit width of greater than 10 cm.

7. The fibrous structure according to claim 1 wherein pattern comprises an emboss pattern.

8. The fibrous structure according to claim 1 wherein pattern comprises a water-resistant pattern.

9. The fibrous structure according to claim 1 wherein the fibrous structure is in roll form.

10. A single- or multi-ply sanitary tissue product comprising a fibrous structure according to claim 1.

11. A method for making a fibrous structure, the method comprising the step of imparting a pattern to a fibrous structure comprising individual sheets separably connected to one another wherein the pattern exhibits a repeat unit length along two or more of the individual sheets of greater than 28 cm.

12. The method according to claim 11 wherein the step of imparting a pattern comprises passing a fibrous structure through an embossing nip comprising at least one embossing roll comprising the pattern.

13. The method according to claim 11 wherein the step of imparting a pattern comprises contacting a fibrous structure with a patterned belt comprising the pattern such that the pattern is imparted to the fibrous structure.

14. A fibrous structure comprising a first pattern having a repeat unit length of greater than 28 cm and a second pattern different from the first pattern having a repeat unit length of greater than 28 cm, wherein the first pattern has an pattern depth of at least 50 μm greater than the pattern depth of the second pattern.

15. The fibrous structure according to claim 14 wherein the first and second patterns are registered to one another.
